(19) United States
(12) Patent Application Publication
(10) Pub. No.: US 2024/0223963 A1
(43) Pub. Date: Jul. 4, 2024

(54) APPARATUS

(71) Applicant: LG Display Co., Ltd., Seoul (KR)

(72) Inventors: Yong-Su HAM, Paju-si (KR); Minji KIM, Paju-si (KR); SangWoo JIN, Paju-si (KR)

(73) Assignee: LG Display Co., Ltd., Seoul (KR)

(21) Appl. No.: 18/388,065

(22) Filed: Nov. 8, 2023

(30) Foreign Application Priority Data
Dec. 30, 2022 (KR) 10-2022-0190419

(51) Int. Cl. H04R 17/10

(52) U.S. Cl. CPC H04R 17/10; H04R 2217/01

(57) ABSTRACT

An apparatus is provided for outputting sound. The apparatus includes a vibration member including an internal space and a vibration device configured to vibrate the vibration member. The apparatus may enhance a sound characteristic of a low-pitched sound band as well as a high-pitched sound band. Further, the apparatus may provide a wide pitched sound band and improve a flatness of a sound pressure level.

### CROSS-REFERENCE TO RELATED APPLICATION

This application claims the benefit of the Korean Patent Application No. 10-2022-0190419 filed on Dec. 30, 2022, which is hereby incorporated by reference as if fully set forth herein for all purposes.

### BACKGROUND

### Technical Field

The present disclosure relates to an apparatus, and more particularly, to an apparatus for outputting a sound.

### Description of the Related Art

Apparatuses include a separate speaker or sound apparatus for providing sounds. The apparatuses include a vibration meter which converts an input electrical signal into a physical vibration. As a sound apparatus, piezoelectric speakers including a piezoelectric device are known as being lightweight and providing low power consumption, and thus, are being used for various purposes.

However, in a piezoelectric devices used in such piezoelectric speakers, a lowest resonance frequency generally increases due to high stiffness within the piezoelectric speakers, which results in a sound pressure level (i.e. a volume) of a low-pitched sound band being insufficient (not loud enough).

Therefore, piezoelectric speakers may not be sufficient in sound pressure level of the low-pitched sound band within the piezoelectric speakers. Further, due to this limitation, apparatuses including such a piezoelectric speaker can have the same or similar technical issue where the sound pressure level of the low-pitched sound band is not sufficient.

### SUMMARY

Therefore, the inventors have recognized these limitations described above and have performed various research and experiments for enhancing a sound characteristic and/or a sound pressure level characteristic of an apparatus or a sound apparatus. Based on the various research and experiments, the inventors have invented an improved apparatus for enhancing a sound characteristic and/or a sound pressure level characteristic of a low-pitched sound band of an apparatus.

Accordingly, embodiments of the present disclosure are directed to an apparatus that substantially obviates one or more of the problems due to limitations and disadvantages of the related art.

An aspect of the present disclosure is to provide an apparatus for enhancing a sound characteristic and/or a sound pressure level characteristic of a low-pitched sound band.

Another aspect of the present disclosure is to provide an apparatus for enhancing a sound characteristic and/or a sound pressure level characteristic of a high-pitched sound band.

Another aspect of the present disclosure is to provide an apparatus for enhancing a sound characteristic and/or a sound pressure level characteristic of a wide pitched sound band and improving the flatness of a sound pressure level.

Additional features and aspects will be set forth in the description that follows, and in part will be apparent from the description, or may be learned by practice of the inventive concepts provided herein. Other features and aspects of the inventive concepts may be realized and attained by the structure particularly pointed out in the written description, or derivable therefrom, and the claims hereof as well as the appended drawings.

To achieve these and other aspects of the inventive concepts, as embodied and broadly described herein, an apparatus may comprise a vibration member including an internal space and a vibration device configured to vibrate the vibration member.

According to an embodiment of the present disclosure, an apparatus for enhancing a sound characteristic and/or a sound pressure level characteristic of a low-pitched sound band may be provided.

According to an embodiment of the present disclosure, an apparatus for enhancing a sound characteristic and/or a sound pressure level characteristic of a high-pitched sound band may be provided.

According to an embodiment of the present disclosure, an apparatus for enhancing a sound characteristic and/or a sound pressure level characteristic of a wide pitched sound band and improving the flatness of a sound pressure level may be provided.

According to an embodiment of the present disclosure, a piezoelectric device which is lightweight and has low power consumption may be used and a sound characteristic and/or a sound pressure level characteristic of the low-pitched sound band may be enhanced, and thus, an apparatus for realizing or implementing low power consumption and lightness may be provided.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the present disclosure. Nothing in this section should be taken as a limitation on the present disclosure. Further aspects and advantages are discussed below in conjunction with aspects of the disclosure.

It is to be understood that both the foregoing description and the following description are exemplary and explanatory and are intended to provide further explanation of the inventive concepts as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain principles of the disclosure.

FIG. 1 illustrates an apparatus according to an embodiment of the present disclosure.

FIG. 2 is a cross-sectional view taken along line I-I′ illustrated in FIG. 1 according to an embodiment of the present disclosure.

FIG. 3 is a cross-sectional view taken along line I-I′ illustrated in FIG. 1 according to another embodiment of the present disclosure.

FIG. 4 illustrates the arrangement of one or more middle members illustrated in FIG. 3 according to another embodiment of the present disclosure.

FIG. 5 illustrates an arrangement structure of one or more middle members according to another embodiment of the present disclosure.

FIG. 6 illustrates a vibration device according to an embodiment of the present disclosure.

FIG. 7 is a cross-sectional view taken along line II-II′ illustrated in FIG. 6 according to an embodiment of the present disclosure.

FIGS. 8A to 8E illustrate a vibration layer according to various embodiments of the present disclosure.

FIG. 9 illustrates a sound output characteristic of an apparatus according to an experimental example and an embodiment of the present disclosure.

FIG. 10 illustrates a sound output characteristic of an apparatus according to an experimental example and an embodiment of the present disclosure.

FIG. 11 illustrates a sound characteristic of an apparatus according to an embodiment of the present disclosure.

FIG. 12 illustrates a sound characteristic of an apparatus according to an experimental example and an embodiment of the present disclosure.

FIG. 13 illustrates a sound characteristic of an apparatus according to an experimental example and an embodiment of the present disclosure.

FIG. 14 illustrates a sound characteristic of an apparatus according to an experimental example and an embodiment of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction of thereof may be exaggerated for clarity, illustration, and/or convenience.

### DETAILED DESCRIPTION

Reference is now made in detail to embodiments of the present disclosure, examples of which may be illustrated in the accompanying drawings. In the following description, when a detailed description of well-known functions, structures or configurations may unnecessarily obscure aspects of the present disclosure, the detailed description thereof may have been omitted for brevity. Further, repetitive descriptions may be omitted for brevity. The progression of processing steps and/or operations described is an example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete, to assist those skilled in the art to understand the inventive concepts without limiting the protected scope of the present disclosure.

Shapes (e.g., sizes, lengths, widths, heights, thicknesses, locations, radii, diameters, and areas), sizes, ratios, angles, numbers, and the like disclosed herein, including those illustrated in the drawings are merely examples, and thus, the present disclosure is not limited to the illustrated details. Any implementation described herein as an “example” is not necessarily to be construed as preferred or advantageous over other implementations. It is, however, noted that the relative dimensions of the components illustrated in the drawings are part of the present disclosure.

When the term “comprise,” “have,” “include,” “contain,” “constitute,” “made of,” “formed of,” or the like is used with respect to one or more elements, one or more other elements may be added unless a term such as “only” or the like is used. The terms used in the present disclosure are merely used in order to describe example embodiments, and are not intended to limit the scope of the present disclosure. The terms of a singular form may include plural forms unless the context clearly indicates otherwise.

The word “exemplary” is used to mean serving as an example or illustration. Aspects are example aspects. “Embodiments,” “examples,” “aspects,” and the like should not be construed as preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, element, feature, or corresponding information (e.g., a level, range, dimension, size, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

In describing a positional relationship, when the positional relationship between two parts (e.g., layers, films, regions, components, sections, or the like) is described, for example, using “on,” “upon,” “on top of,” “over,” “under,” “above,” “below,” “beneath,” “near,” “close to,” “adjacent to,” “beside,” “next to,” “at or on a side of,” or the like, one or more parts may be located between two other parts unless a more limiting term, such as “immediate(ly),” “direct(ly),” or “close(ly),” is used. For example, when a structure is described as being positioned “on,” “upon,” “on top of,” “over,” “under,” “above,” “below,” “beneath,” “near,” “close to,” “adjacent to,” “beside,” “next to,” “at or on a side of,” or the like another structure, this description should be construed as including a case in which the structures contact each other as well as a case in which one or more additional structures are disposed or interposed therebetween. Furthermore, the terms “front,” “rear,” “back,” “left,” “right,” “top,” “bottom,” “downward,” “upward,” “upper,” “lower,” “up,” “down,” “column,” “row,” “vertical,” “horizontal,” and the like refer to an arbitrary frame of reference.

Spatially relative terms, such as “below,” “beneath,” “lower,” “on,” “above,” “upper” and the like, can be used to describe a correlation between various elements (e.g., layers, films, regions, components, sections, or the like) as shown in the drawings. The spatially relative terms are to be understood as terms including different orientations of the elements in use or in operation in addition to the orientation depicted in the drawings. For example, if the elements shown in the drawings are turned over, elements described as “below” or “beneath” other elements would be oriented “above” other elements. Thus, the term “below,” which is an example term, can include all directions of “above” and “below.” Likewise, an exemplary term “above” or “on” can include both directions of “above” and “below.”

In describing a temporal relationship, when the temporal order is described as “after,” “subsequent,” “next,” “before,” “preceding,” “prior to,” or the like a case which is not consecutive or not sequential may be included and thus one or more other events may occur therebetween, unless a more limiting term, such as “just,” “immediate(ly),” or “direct(ly)” is used.

The terms, such as “below,” “lower,” “above,” “upper” and the like, may be used herein to describe a relationship between element(s) as illustrated in the drawings. It will be understood that the terms are spatially relative and based on the orientation depicted in the drawings.

It is understood that, although the terms “first”, “second,” or the like may be used herein to describe various elements (e.g., layers, films, regions, components, sections, or the like), these elements should not be limited by these terms, for example, to any particular order, sequence, precedence, or number of elements. These terms are used only to partition one element from another. For example, a first element could be a second element, and, similarly, a second element could be a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

For the expression that an element (e.g., layer, film, region, component, section, or the like) is “connected,” “coupled,” “attached,” “adhered,” or the like to another element, the element can not only be directly connected, coupled, attached, adhered, or the like to another element, but also be indirectly connected, coupled, attached, adhered, or the like to another element with one or more intervening elements disposed or interposed between the elements, unless otherwise specified.

For the expression that an element (e.g., layer, film, region, component, section, or the like) is “contacts,” “overlaps,” or the like with another element, the element can not only directly contact, overlap, or the like with another element, but also indirectly contact, overlap, or the like with another element with one or more intervening elements disposed or interposed between the elements, unless otherwise specified.

The phase that an element (e.g., layer, film, region, component, section, or the like) is “provided in,” “disposed in,” or the like in another element may be understood as that at least a portion of the element is provided in, disposed in, or the like in another element, or that the entirety of the element is provided in, disposed in, or the like in another element. The phase that an element (e.g., layer, film, region, component, section, or the like) “contacts,” “overlaps,” or the like with another element may be understood as that at least a portion of the element contacts, overlaps, or the like with a least a portion of another element, that the entirety of the element contacts, overlaps, or the like with a least a portion of another element, or that at least a portion of the element contacts, overlaps, or the like with the entirety of another element.

The terms such as a “line” or “direction” should not be interpreted only based on a geometrical relationship in which the respective lines or directions are parallel or perpendicular to each other, and may be meant as lines or directions having wider directivities within the range within which the components of the present disclosure can operate functionally. For example, the terms “first direction,” “second direction,” and the like, such as a direction parallel or perpendicular to “x-axis,” “y-axis,” or “z-axis,” should not be interpreted only based on a geometrical relationship in which the respective directions are parallel or perpendicular to each other, and may be meant as directions having wider directivities within the range within which the components of the present disclosure can operate functionally.

The term “at least one” should be understood as including any and all combinations of one or more of the associated listed items. For example, each of the phrases of “at least one of a first item, a second item, or a third item” and “at least one of a first item, a second item, and a third item” may represent (i) a combination of items provided by two or more of the first item, the second item, and the third item or (ii) only one of the first item, the second item, or the third item.

The expression of a first element, a second elements “and/or” a third element should be understood as one of the first, second and third elements or as any or all combinations of the first, second and third elements. By way of example, A, B and/or C can refer to only A: only B: only C: any of A, B, and C (e.g., A, B, or C); or some or some combination of A, B, and C (e.g., A and B; A and C: or B and C); or all of A, B, and C. Furthermore, an expression “A/B” may be understood as A and/or B. For example, an expression “A/B” can refer to only A: only B: A or B: or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element (e.g., layer, film, region, component, sections, or the like) is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

Features of various embodiments of the present disclosure may be partially or entirety coupled to or combined with each other, may be technically associated with each other, and may be variously inter-operated, linked or driven together. The embodiments of the present disclosure may be implemented or carried out independently of each other, or may be implemented or carried out together in a co-dependent or related relationship. In one or more aspects, the components of each apparatus according to various embodiments of the present disclosure are operatively coupled and configured.

Unless otherwise defined, the terms (including technical and scientific terms) used herein have the same meaning as commonly understood by one of ordinary skill in the art to which example embodiments belong. It is further understood that terms, such as those defined in commonly used dictionaries, should be interpreted as having a meaning that is, for example, consistent with their meaning in the context of the relevant art and should not be interpreted in an idealized or overly formal sense unless expressly defined otherwise herein.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for convenience of description, a scale, dimension, size, and thickness of each of the elements illustrated in the accompanying drawings may be different from an actual scale, dimension, size, and thickness, and thus, embodiments of the present disclosure are not limited to a scale, dimension, size, and thickness illustrated in the drawings.

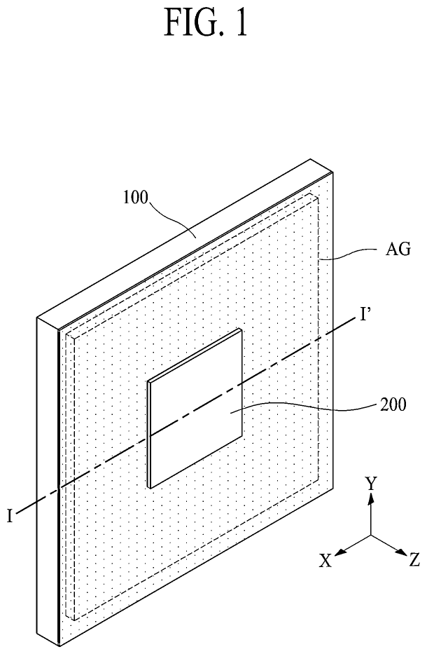

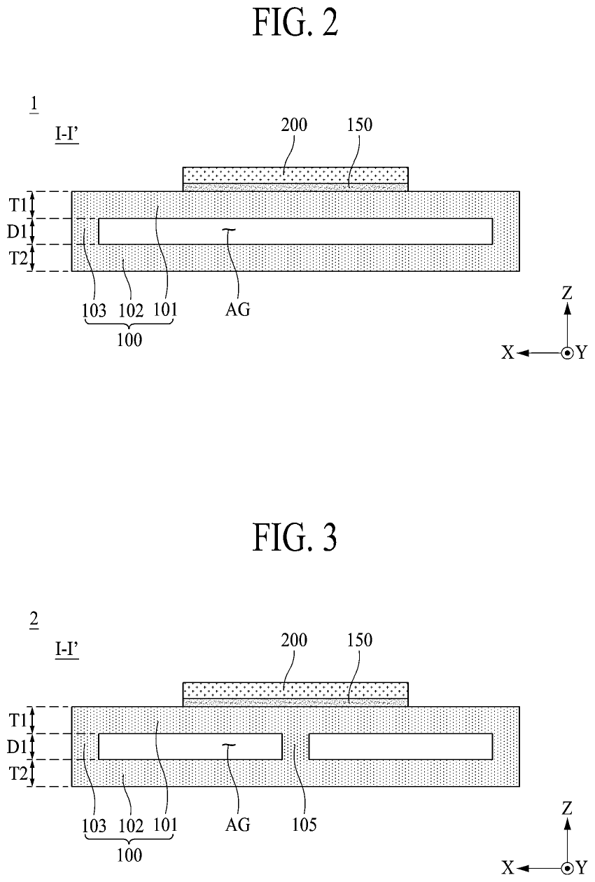

FIG. 1 illustrates an apparatus according to an embodiment of the present disclosure. FIG. 2 is a cross-sectional view taken along line I-I′ illustrated in FIG. 1 according to an embodiment of the present disclosure.

Referring to FIGS. 1 and 2, an apparatus 1 according to an embodiment of the present disclosure may be implemented or provided as a sound apparatus, a sound output apparatus, a vibration apparatus, a vibration generating apparatus, a sound bar, a sound system, a sound apparatus for electronic apparatuses, a sound apparatus for display apparatuses, a sound apparatus for vehicular apparatus, or a sound bar for vehicular apparatus. For example, the vehicular apparatus or the transporting apparatus may include one or more of seat and one or more of window. For example, the vehicular apparatus or the transporting apparatus may include a vehicle, a train, a ship, or an aircraft, but embodiments of the present disclosure are not limited thereto. The apparatus 1 according to an embodiment of the present disclosure may be implemented or provided as a signage panel such as an analog signage or digital signage such as an advertisement signboard, a poster, and a guide board.

The apparatus 1 according to an embodiment of the present disclosure may be a display apparatus which includes a plurality of pixels, but embodiments of the present disclosure are not limited thereto.

The display apparatus may include a display panel, including a plurality of pixels implementing a black and white, or color image, and a driver for driving the display panel. Each of the plurality of pixels may be a subpixel configuring one of a plurality of colors implementing a color image. An apparatus according to an embodiment of the present disclosure may include a notebook computer, a television (TV), a computer monitor, an equipment apparatus including a specific form of a vehicle or a vehicular or automotive apparatus, and a set device (or a set apparatus) or a set electronic apparatus such as a smartphone or an electronic pad, which are complete products (or final products) including a display panel such as a liquid crystal display panel or an organic light emitting display panel.

The apparatus 1 according to an embodiment of the present disclosure may include a vibration member 100 and a vibration device 200.

The vibration member 100 may generate or output a vibration (or a sound wave), based on a displacement (or driving) of the vibration device 200. The vibration member 100 may be a vibration object, a display member, a display panel, a signage panel, a passive vibration member, a passive vibration plate, a front member, a rear member, a vibration panel, a sound panel, a passive vibration panel, a sound output plate, a sound vibration plate, or an image screen, but embodiments of the present disclosure are not limited thereto.

The vibration member 100 may be a display panel which includes a display part (or a screen) including a plurality of pixels for implementing a black and white, or color image. Therefore, the vibration member 100 may generate one or more of a vibration and a sound, based on a displacement (or driving) of the vibration device 200. For example, the vibration member 100 may vibrate based on a displacement (or driving) of the vibration device 200 while displaying an image on the display part, and thus, may generate or output a sound synchronized with the image displayed on the display part, but embodiments of the present disclosure are not limited thereto.

The vibration member 100 may be configured to be transparent, semitransparent, or opaque. The vibration member 100 may include a metal material having a material property suitable for outputting sound in accordance with vibration or may include a non-metal material (or a composite non-metal material).

According to an embodiment of the present disclosure, the metal material of the vibration member 100 may include at least one of stainless steel, aluminum (Al), an aluminum (Al) alloy, magnesium (Mg), a magnesium (Mg) alloy, or a magnesium lithium (Mg—Li) alloy, but embodiments of the present disclosure are not limited thereto. For example, the vibration member 100 may include a metal material such as the aluminum (Al), or may include a plastic material such as plastic or styrene material, but embodiments of the present disclosure are not limited thereto. For example, the styrene material may be an ABS material. The ABS material may be acrylonitrile, butadiene, or styrene.

According to another embodiment of the present disclosure, the nonmetal material (or the composite nonmetal material) of the vibration member 100 may include one or more of plastic, fiber, leather, wood, cloth, rubber, carbon, glass, and paper, but embodiments of the present disclosure are not limited thereto. For example, the paper may be a cone paper for speakers. For example, the cone paper may be pulp or foam plastic, but embodiments of the present disclosure are not limited thereto.

The vibration member 100 may have a planar structure. For example, the vibration member 100 may include a flat plate structure having a polygonal shape including a rectangular shape or a square shape. For example, the vibration member 100 may include a flat plate structure having the same overall thickness or may include a non-planar structure, but embodiments of the present disclosure are not limited thereto.

The vibration member 100 may include a horizontal length parallel with a first direction X and a vertical length parallel with a second direction Y crossing the first direction X. For example, with respect to the same plane, the first direction X may be a first horizontal direction, that is to say, a first horizontal length direction of the vibration member 100, the second direction Y may be a second horizontal direction intersecting with the first direction X, that is to say, a second horizontal length direction of the vibration member 100. According to an embodiment of the present disclosure, the vibration member 100 may include a rectangular shape where the horizontal length is relatively longer than the vertical length, or may include a square shape where the horizontal length is equal to the vertical length, but embodiments of the present disclosure are not limited thereto.

The vibration member 100 according to an embodiment of the present disclosure may include an internal space AG (or an air gap). The internal space AG of the vibration member 100 may be provided to be isolated from the outside. For example, the internal space AG of the vibration member 100 may have an isolated or closed structure with respect to the outside. The vibration member 100 may include a box shape surrounding the internal space AG. For example, the internal space AG of the vibration member 100 may be an air gap, an air space, an air pocket, an air suspension, an air damper, or a closed space, but embodiments of the present disclosure are not limited thereto.

The vibration member 100 according to an embodiment of the present disclosure may include a first vibration member 101, a second vibration member 102, and a third vibration member 103. The first vibration member 101, the second vibration member 102, and the third vibration member 103 of the vibration member 100 may be integrated. For example, the first vibration member 101, the second vibration member 102, and the third vibration member 103 of the vibration member 100 may be provided as one body. Therefore, the internal space AG surrounded by the third vibration member 103 may be provided between the first vibration member 101 and the second vibration member 102. For example, the vibration member 100 may have a box shape including the internal space AG as the first vibration member 101, the second vibration member 102, and the third vibration member 103 are integrated. A certain air gap may be formed in the internal space AG of the vibration member 100. For example, the internal space AG of the vibration member 100 may be configured with (or filled with) air or a gas, but embodiments of the present disclosure are not limited thereto.

The first vibration member 101 and the second vibration member 102 may be provided to be spaced apart from each other in a third direction Z. For example, the third direction Z may be a vertical direction or a thickness direction of the vibration member 100. The first vibration member 101 and the second vibration member 102 may be spaced apart from each other to have a first interval D1 (or distance) in the third direction Z. For example, the first vibration member 101 may be arranged in parallel with the second vibration member 102 with the internal space AG, having a height of the first interval D1, therebetween.

The third vibration member 103 may be provided to connect between the first vibration member 101 and the second vibration member 102. The third vibration member 103 may be connected with or coupled to an edge portion (or a periphery portion) of the first vibration member 101. Also, the third vibration member 103 may be connected with or coupled to an edge portion (or a periphery portion) of the second vibration member 102. For example, the third vibration member 103 may be provided to surround the internal space AG between the first vibration member 101 and the second vibration member 102. For example, the internal space AG of the vibration member 100 may be fully surrounded by the first vibration member 101, the second vibration member 102, and the third vibration member 103.

The third vibration member 103 may be bent and extend from an edge portion (or a periphery portion) of the first vibration member 101 or the second vibration member 102. For example, the third vibration member 103 may be parallel to the third direction Z. The third vibration member 103 may be integrated with the first vibration member 101 and the second vibration member 102. For example, the third vibration member 103 may be provided as one body with the first vibration member 101 and the second vibration member 102.

According to an embodiment of the present disclosure, the vibration member 100 may include a same material or a single material. For example, the first vibration member 101, the second vibration member 102, and the third vibration member 103 of the vibration member 100 may include a same material or a single material. For example, the first vibration member 101, the second vibration member 102, and the third vibration member 103 may include a plastic material of a styrene material or plastic, but embodiments of the present disclosure are not limited thereto. The plastic material may be a polypropylene material. Also, the styrene material may be an ABS material. The ABS material may be acrylonitrile, butadiene, or styrene.

According to an embodiment of the present disclosure, each of the first vibration member 101, the second vibration member 102, and the third vibration member 103 may include a same material or a single material. The first vibration member 101, the second vibration member 102, and the third vibration member 103 may be connected with or coupled to one another by direct welding (or bonding or fusion) therebetween without a heterogeneous adhesive material. For example, the first vibration member 101, the second vibration member 102, and the third vibration member 103 may be directly connected with or coupled to one another by ultrasonic welding therebetween.

According to an embodiment of the present disclosure, the first vibration member 101 and the second vibration member 102 may have a same thickness. For example, the first vibration member 101 may have a first thickness T1. Also, the second vibration member 102 may have a second thickness T2. The first thickness T1 of the first vibration member 101 may be equal to the second thickness T2 of the second vibration member 102. Also, the first interval D1 between the first vibration member 101 and the second vibration member 102 may be equal to the first thickness T1 of the first vibration member 101, or may be equal to the second thickness T2 of the second vibration member 102. For example, the first thickness T1 of the first vibration member 101, the second thickness T2 of the second vibration member 102, and the first interval D1 of the internal space AG may have a ratio of 1:1:1.

The vibration member 100 according to an embodiment of the present disclosure may include the internal space AG (or an air gap). The vibration member 100 may be configured with the first vibration member 101 and the second vibration member 102 which are spaced apart from each other with the internal space AG therebetween while maintaining a total thickness, and thus, the stiffness of each of the first vibration member 101 and the second vibration member 102 may be lower than a case which has the total thickness, thereby decreasing a lowest resonance frequency (or a lowest natural frequency) of the vibration member 100. Therefore, as the lowest resonance frequency (or the lowest natural frequency) based on the internal space AG of the vibration member 100 is reduced, the vibration member 100 may vibrate at a relatively low frequency. Therefore, a sound characteristic and/or a sound pressure level characteristic of a low-pitched sound band generated based on a vibration of the vibration member 100 may be enhanced. Also, the vibration member 100 may be provided as a closed space in a state where the internal space AG includes air, and thus, may maintain an impedance component (or an air impedance or an elastic impedance) based on air. Accordingly, a vibration of one of the first vibration member 101 and the second vibration member 102 may be smoothly transferred to the other of the first vibration member 101 and the second vibration member 102, and thus, a sound characteristic and/or a sound pressure level characteristic of the low-pitched sound band generated based on a vibration of the vibration member 100 may be enhanced and the quality of a sound of a high-pitched sound band may be enhanced.

The vibration device 200 may be configured to vibrate the vibration member 100. The vibration device 200 may be disposed or provided in the vibration member 100. The vibration device 200 may vibrate based on a driving signal (or a vibration driving signal or a voice signal) applied to the vibration device 200 to vibrate (or displace) the vibration member 100. For example, the vibration device 200 may be a vibration apparatus, a vibration structure, a vibration generating device, a vibration generating apparatus, a vibration generator, a sounder, a sound device, a sound generating device, a sound apparatus, a sound generating apparatus, or a sound generator, but embodiments of the present disclosure are not limited thereto.

The vibration device 200 may include a piezoelectric material or an electroactive material having a piezoelectric characteristic. The vibration device 200 may vibrate (or displace or drive) the vibration member 100 according to a vibration (or displacement or driving) of a piezoelectric material based on a driving signal (or a vibration driving signal or a voice signal) applied to the piezoelectric material. For example, the vibration device 200 may alternately contract and/or expand based on a piezoelectric effect, and thus, may vibrate (or displace or drive). For example, the vibration device 200 may alternately contract and/or expand based on an inverse piezoelectric effect, and thus, may vibrate (or displace or drive) in a vertical direction (or a thickness direction) Z.

The vibration device 200 according to an embodiment of the present disclosure may include a tetragonal shape which has a first length parallel to a first direction X and a second length parallel to a second direction Y in a plan view. For example, the vibration device 200 may include a rectangular shape where one of the first length and the second length is relatively long, or may include a square shape where the first length is equal to the second length in a plan view, but embodiments of the present disclosure are not limited thereto.

The vibration device 200 according to an embodiment of the present disclosure may be connected with or coupled to a first surface (or an upper surface) or a second surface (or a lower surface) of the vibration member 100 by an adhesive member 150. For example, the adhesive member 150 may be disposed between the vibration member 100 and the vibration device 200. For example, the vibration device 200 may be connected with or coupled to a first surface (or an upper surface) of the first vibration member 101. Also, the vibration device 200 may be connected with or coupled to a second surface (or a lower surface) of the second vibration member 102.

The adhesive member 150 according to an embodiment of the present disclosure may include an adhesive layer (or a tacky layer) which is good in adhesive force or attaching force. For example, the adhesive member 150 may include an adhesive, a double-sided adhesive, a double-sided adhesive tape, a double-sided adhesive foam tape, a double-sided foam pad, or a tacky sheet, but embodiments of the present disclosure are not limited thereto. For example, when the adhesive member 150 includes a tacky sheet (or a tacky layer), the adhesive member 150 may include only an adhesive layer or a tacky layer without a base member such as a plastic material.

The adhesive layer (or the tacky layer) of the adhesive member 150 according to an embodiment of the present disclosure may include epoxy, acryl, silicone, or urethane, but embodiments of the present disclosure are not limited thereto.

The adhesive layer (or the tacky layer) of the adhesive member 150 according to an embodiment of the present disclosure may include a pressure sensitive adhesive (PSA), an optically cleared adhesive (OCA), or an optically cleared resin (OCR), but embodiments of the present disclosure are not limited thereto.

The vibration device 200 according to an embodiment of the present disclosure may overlap the internal space AG (or an air gap) of the vibration member 100. For example, at least a portion of the internal space AG of the vibration member 100 may overlap the vibration device 200.

The internal space AG of the vibration member 100 may have a size which differs from that of the vibration device 200 in a horizontal direction X-Y of the vibration member 100, or may have a size which is greater than or equal to that of the vibration device 200. For example, the internal space AG of the vibration member 100 may be provided to have a size which is greater than that of the vibration device 200. A center portion of the vibration device 200 may overlap a center portion of the internal space AG of the vibration member 100.

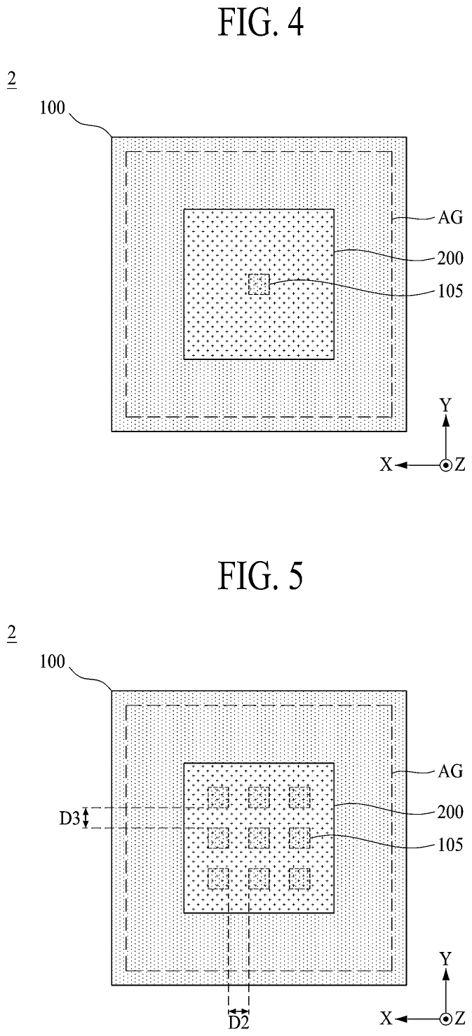

FIG. 3 is a cross-sectional view taken along line I-I′ illustrated in FIG. 1 according to another embodiment of the present disclosure. FIG. 4 illustrates the arrangement of one or more middle members illustrated in FIG. 3 according to another embodiment of the present disclosure. FIGS. 3 and 4 illustrate an embodiment where one or more middle members are additionally provided in the apparatus 1 described above with reference to FIGS. 1 and 2. In the following description, therefore, like elements other than one or more middle members and relevant elements are referred to by like reference numerals, and repeated descriptions thereof may be omitted or will be briefly given.

Referring to FIGS. 3 and 4, an apparatus 2 according to another embodiment of the present disclosure may include one or more middle members 105. For example, the apparatus 2 according to another embodiment of the present disclosure may include one or more middle members 105.

The one middle member 105 according to another embodiment of the present disclosure may be provided in an internal space AG of a vibration member 100. The one middle member 105 may be configured to reinforce the stiffness of a first vibration member 101 and a second vibration member 102. The one middle member 105 may be provided between the first vibration member 101 and the second vibration member 102 of the vibration member 100. For example, the one middle member 105 may be connected with or coupled to the first vibration member 101 and the second vibration member 102 of the vibration member 100. The one middle member 105 may be provided to support each of the first vibration member 101 and the second vibration member 102 of the vibration member 100. For example, the one middle member 105 may have a polygonal pillar shape or a circular pillar shape, but embodiments of the present disclosure are not limited thereto. For example, the one middle member 105 may be a rod or a pillar, but embodiments of the present disclosure are not limited thereto.

According to another embodiment of the present disclosure, the one middle member 105 may be provided as one body with the vibration member 100. The middle member 105 may be integral with the vibration member 100. For example, the one middle member 105 may include a single material or a same material as that of the vibration member 100. For example, the one middle member 105 may include a single material or a same material as that of each of the first vibration member 101, the second vibration member 102, and the third vibration member 103 of the vibration member 100. For example, the one middle member 105 may include a plastic material of a styrene material or plastic, but embodiments of the present disclosure are not limited thereto. The plastic material may be a polypropylene material. Also, the styrene material may be an ABS material. The ABS material may be acrylonitrile, butadiene, or styrene.

According to another embodiment of the present disclosure, the one middle member 105 may be connected with or coupled to the vibration member 100 as one body by direct welding (or bonding or fusion) therebetween without a heterogeneous adhesive material. For example, the one middle member 105 may be directly connected with or coupled to the vibration member 100 by ultrasonic welding therebetween.

According to another embodiment of the present disclosure, the one middle member 105 may be provided to overlap the vibration device 200. For example, the one middle member 105 may be disposed in an internal space AG of the vibration member 100 to overlap a center portion of the vibration device 200. For example, the one middle member 105 may be connected with or coupled to the first vibration member 101 and the second vibration member 102 of the vibration member 100 to overlap the center portion of the vibration device 200.

According to another embodiment of the present disclosure, the one middle member 105 may be provided to support the first vibration member 101 and the second vibration member 102 of the vibration member 100, and thus, may prevent a fluctuation of a vibration mode between the first vibration member 101 and the second vibration member 102 and may prevent an increase in peak and/or dip of the first vibration member 101 and the second vibration member 102. For example, the one middle member 105 may prevent an increase in peak and/or dip of a high-pitched sound band among sound bands of a sound generated based on a vibration of the vibration member 100, and moreover, peak and/or dip may decrease in a sound of the high-pitched sound band, thereby improving the flatness of a sound pressure level.

FIG. 5 illustrates an arrangement structure of one or more middle members according to another embodiment of the present disclosure. FIG. 5 illustrates an embodiment implemented by modifying an arrangement structure of the one or more middle members illustrated in FIGS. 3 and 4.

Referring to FIGS. 3 and 5, the apparatus 2 according to another embodiment of the present disclosure may include a plurality of middle members 105. For example, the apparatus 2 according to another embodiment of the present disclosure may include nine middle members 105 or first to ninth middle members 105, but embodiments of the present disclosure are not limited thereto. For example, the plurality of middle members 105 may include two or more middle members 105.

Each of the plurality of middle members 105 may be configured to overlap the vibration device 200. For example, the plurality of middle members 105 may be arranged to be equally distributed at the center portion of the vibration device 200 and a periphery of the center portion of the vibration device 200. For example, the plurality of middle members 105 may be disposed in the internal space AG of the vibration member 100 to overlap the center portion of the vibration device 200 and the periphery of the center portion of the vibration device 200. In a further example, the middle members 105 may be equally distributed across the vibration device 200. The plurality of middle members 105 may be connected with or coupled to the first vibration member 101 and the second vibration member 102 of the vibration member 100 to overlap the center portion of the vibration device 200 and the periphery of the center portion of the vibration device 200.

The plurality of middle members 105 may be arranged to have an equal interval (distance) or the same interval in a first direction X or a second direction Y intersecting with the first direction X. For example, the plurality of middle members 105 may be arranged to have a second interval (distance) D2 in the first direction X. Also, the plurality of middle members 105 may be arranged to have a third interval (distance) D3 in the second direction Y. For example, the second interval D2 may be different from or equal to the third interval D3, but embodiments of the present disclosure are not limited thereto. For example, one middle member 105 of the plurality of middle members 105 may be disposed at the center portion of the vibration member 200, and the plurality of middle members 105 may be arranged to have the second interval D2 in the first direction X and have the third interval D3 in the second direction Y, with respect to a middle member 105 disposed at the center portion.

According to another embodiment of the present disclosure, in FIG. 5, the middle member 105 may be provided in plurality and a structure may be provided where the plurality of middle members 105 are disposed at a plurality of positions. The plurality of middle members 105 according to another embodiment of the present disclosure may support the first vibration member 101 and the second vibration member 102 of the vibration member 100 and may be configured so that an area supporting the first vibration member 101 and the second vibration member 102 increases, and thus, a thickness of the first vibration member 101 and the second vibration member 102 may be reduced.

For example, a peak portion of a sound generated based on a vibration of the vibration member 100 may move a low-pitched sound band area as a thickness of the first vibration member 101 and the second vibration member 102 is progressively thinned. Accordingly, the plurality of middle members 105 according to another embodiment of the present disclosure may move primary peak of a sound (or a sound pressure level), generated based on a vibration of the vibration member 100, to the low-pitched sound band, thereby increasing or enhancing a sound characteristic and/or a sound pressure level characteristic of the low-pitched sound band. Also, the plurality of middle members 105 may be provided to support the first vibration member 101 and the second vibration member 102 of the vibration member 100, and thus, may prevent a fluctuation of a vibration mode between the first vibration member 101 and the second vibration member 102 and may prevent an increase in peak and/or dip of the first vibration member 101 and the second vibration member 102. For example, the plurality of middle members 105 may prevent an increase in peak and/or dip of a high-pitched sound band among sound bands of a sound generated based on a vibration of the vibration member 100, and moreover, peak and/or dip may decrease in a sound of the high-pitched sound band, thereby improving the flatness of a sound pressure level.

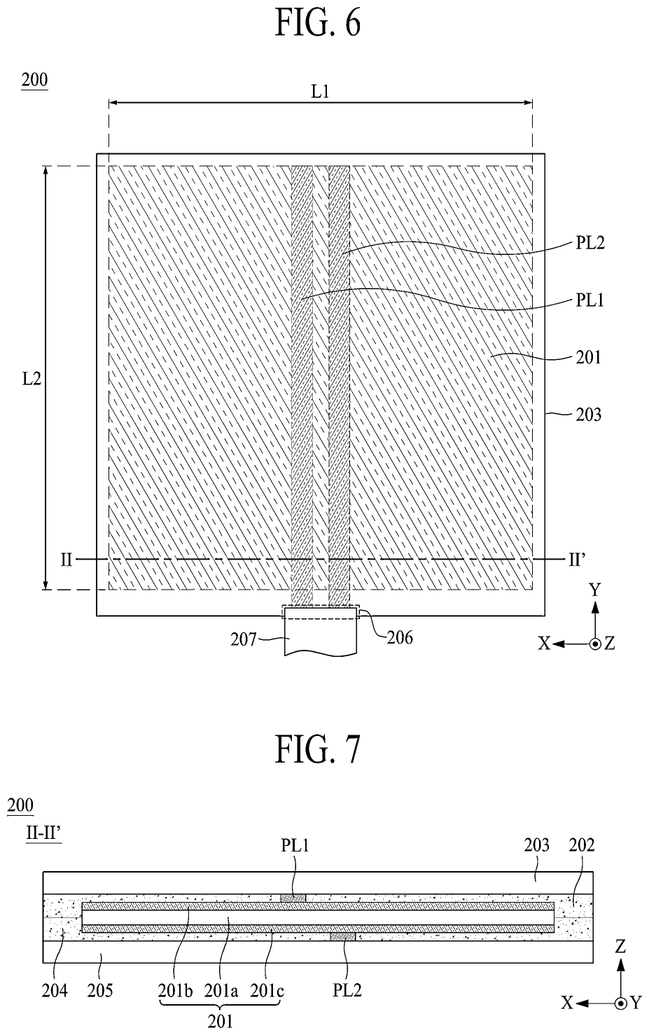

FIG. 6 illustrates a vibration device according to an embodiment of the present disclosure. FIG. 7 is a cross-sectional view taken along line II-II′ illustrated in FIG. 6 according to an embodiment of the present disclosure.

Referring to FIGS. 6 and 7, a vibration device 200 according to an embodiment of the present disclosure may be a vibration structure, a vibrator, a vibration generator, a flexible vibration apparatus, a flexible vibration structure, a flexible vibrator, a flexible vibration generating device, a flexible vibration generator, a flexible sounder, a flexible sound device, a flexible sound generating device, a flexible sound generator, a flexible actuator, a flexible speaker, a flexible piezoelectric speaker, a film actuator, a film type piezoelectric composite actuator, a film speaker, a film type piezoelectric speaker, or a film type piezoelectric composite speaker, but embodiments of the present disclosure are not limited thereto.

The vibration device 200 according to an embodiment of the present disclosure may include at least one vibration part 201. For example, the at least one vibration part 201 may be a piezoelectric vibration part or a piezoelectric-type vibration part.

The at least one vibration part 201 according to an embodiment of the present disclosure may include a tetragonal shape which has a first length L1 parallel to a first direction X and a second length L2 parallel to a second direction Y. For example, the at least one vibration part 201 may include a square shape where the first length L1 is equal to the second length L2, or may include a rectangular shape where one of the first length L1 and the second length L2 is relatively long, or but embodiments of the present disclosure are not limited thereto.

The vibration part 201 according to another embodiment of the present disclosure may include a vibration layer 201a, a first electrode layer 201b, and a second electrode layer 201c.

The vibration layer 201a may include a piezoelectric material or an electroactive material having a piezoelectric effect. For example, the piezoelectric material may have a characteristic where pressure or twisting is applied to a crystalline structure by an external force, a potential difference occurs due to dielectric polarization (or poling) caused by a relative position change of a positive (+) ion and a negative (−) ion, and a vibration is generated by an electric field based on a voltage applied thereto. The vibration layer 201a may be referred to as the terms such as a piezoelectric layer, a piezoelectric material layer, an electroactive layer, a vibration portion, a piezoelectric material portion, an electroactive portion, a piezoelectric structure, a piezoelectric composite layer, a piezoelectric composite, a piezoelectric ceramic composite or the like, but embodiments of the present disclosure are not limited thereto. The vibration layer 201a may include a transparent conductive material, a semitransparent conductive material, or an opaque conductive material and the vibration layer 201a may be transparent, semitransparent, or opaque.

The vibration layer 201a may include an inorganic material portion. The inorganic material portion may include a piezoelectric material, a composite piezoelectric material, or an electroactive material, which has a piezoelectric effect

The vibration layer 201a according to an embodiment of the present disclosure may include a ceramic-based material for generating a relatively high vibration, or may include a piezoelectric ceramic having a perovskite-based crystalline structure. The perovskite crystalline structure may have a piezoelectric effect and/or an inverse piezoelectric effect, and may be a plate-shaped structure having orientation. The perovskite crystalline structure may be represented by a chemical formula “ABO;”. In the chemical formula, “A” may include a divalent metal element, and “B” may include a tetravalent metal element. For example, in the chemical formula “ABO₃”, “A” and “B” may be cations, and “O” may be anions. For example, the first portion 201a1 may include one or more of lead(II) titanate (PbTiO₃), lead zirconate (PbZrO₃), lead zirconate titanate(PbZrTiO₃), barium titanate (BaTiO₃), and strontium titanate (SrTiO₃), but embodiments of the present disclosure are not limited thereto.

The piezoelectric ceramic may include single crystalline ceramic having a single crystalline structure, or may include polycrystalline ceramic or a ceramic material having a polycrystalline structure. A piezoelectric material of the single crystalline ceramic may include α-AlPO₄, α-SiO₂, LiNbO₃, Tb₂(MoO₄)₃, Li₂B₄O₇, or ZnO, but embodiments of the present disclosure are not limited thereto. The piezoelectric material of the single crystalline ceramic may include a lead zirconate titanate (PZT)-based material including lead (Pb), zirconium (Zr), and titanium (Ti) or may include a lead zirconate nickel niobate (PZNN)-based material including lead (Pb), zinc (Zn), nickel (Ni), and niobium (Nb), but embodiments of the present disclosure are not limited thereto.

For another example, the vibration layer 201a may include one or more of CaTiO₃, BaTiO₃, and SrTiO₃ without Pb, but embodiments of the present disclosure are not limited thereto.

The first electrode layer 201b may be disposed on a first surface (or an upper surface) of the vibration layer 201a. For example, the first electrode layer 201b may have a single electrode (or one electrode) shape disposed at the whole first surface of the vibration layer 201a. For example, the first electrode layer 201b may have substantially the same shape as that of the vibration layer 201a, but embodiments of the present disclosure are not limited thereto.

The first electrode layer 201b according to an embodiment of the present disclosure may include a transparent conductive material, a semitransparent conductive material, or an opaque conductive material. For example, the transparent conductive material or the semitransparent conductive material of the first electrode layer 201b may include indium tin oxide (ITO) or indium zinc oxide (IZO), but embodiments of the present disclosure are not limited thereto. The opaque conductive material of the first electrode layer 201b may include gold (Au), silver (Ag), platinum (Pt), palladium (Pd), molybdenum (Mo), magnesium (Mg), carbon, or glass frit-including Ag, or may include an alloy thereof, but embodiments of the present disclosure are not limited thereto. For example, the first electrode layer 201b may include Ag having low resistivity, so as to enhance an electrical characteristic and/or a vibration characteristic of the vibration layer 201a. For example, the carbon may be carbon black, ketjen black, carbon nano tube, or a carbon material including graphite, but embodiments of the present disclosure are not limited thereto.

The second electrode layer 201c may be disposed on a second surface (or a rear surface), which is different from (or opposite to) the first surface, of the vibration layer 201a. For example, the second electrode layer 201c may have a single electrode (or one electrode) shape disposed at the entire second surface of the vibration layer 201a. For example, the second electrode layer 201c may have substantially the same shape as that of the vibration layer 201a, but embodiments of the present disclosure are not limited thereto. The second electrode layer 201c according to an embodiment of the present disclosure may include a transparent conductive material, a semitransparent conductive material, or an opaque conductive material. For example, the second electrode layer 201c may include the same material as that of the first electrode layer 201b, but embodiments of the present disclosure are not limited thereto. As another example of the present disclosure, the second electrode layer 201c may include a material different from that of the first electrode layer 201b.

The vibration layer 201a may be polarized (or poling) by a certain voltage applied to a first electrode layer 201b and a second electrode layer 201c in a certain temperature atmosphere or a temperature atmosphere which is changed from a high temperature to a room temperature, but embodiments of the present disclosure are not limited thereto. For example, the vibration layer 201a may alternately repeat contraction and/or expansion according to an inverse piezoelectric effect based on a vibration driving signal (or a voice signal) applied from the outside to the first electrode layer 201b and the second electrode layer 201c. For example, the vibration layer 201a may vibrate based on a vertical-direction vibration and a lateral-direction vibration by using the first electrode layer 201b and the second electrode layer 201c. A displacement (or a vibration or driving) of a vibration member (or a vibration plate or a vibration object) may increase based on the contraction and/or expansion of the vibration layer 201a in a horizontal direction, and thus, a vibration characteristic of a vibration apparatus may be more enhanced.

The vibration device 200 according to an embodiment of the present disclosure may further include a first cover member 203 and a second cover member 205.

The first cover member 203 may be disposed on a first surface of the vibration device 200. For example, the first cover member 203 may be configured to cover the first electrode layer 201b. Accordingly, the first cover member 203 may protect the first electrode layer 201b.

The second cover member 205 may be disposed on a second surface of the vibration device 200. For example, the second cover member 205 may be configured to cover the second electrode layer 201c. Accordingly, the second cover member 205 may protect the second electrode layer 201c.

Each of the first cover member 203 and the second cover member 205 according to an embodiment of the present disclosure may include one or more materials of plastic, fiber, and wood, but embodiments of the present disclosure are not limited thereto. For example, the first cover member 203 and the second cover member 205 may include the same material or different materials. For example, the first cover member 203 and the second cover member 205 may be a polyimide film or a polyethylene terephthalate film, but embodiments of the present disclosure are not limited thereto.

The first cover member 203 according to an embodiment of the present disclosure may be connected or coupled to the first electrode layer 201b by using a first adhesive layer 202. For example, the first cover member 203 may be connected or coupled to the first electrode layer 201b through a film laminating process using the first adhesive layer 202.

The second cover member 205 according to an embodiment of the present disclosure may be connected or coupled to the second electrode layer 201c by a second adhesive layer 204. For example, the second cover member 205 may be connected or coupled to the second electrode layer 201c through a film laminating process by the first adhesive layer 204.

The first adhesive layer 202 may be disposed between the first electrode layer 201b and the first cover member 203. The second adhesive layer 204 may be disposed between the second electrode layer 201c and the second cover member 205. For example, the first adhesive layer 202 and the second adhesive layer 204 may be provided between the first cover member 203 and the second cover member 205 to fully surround the vibration layer 201a, the first electrode layer 201b, and the second electrode layer 201c. For example, the vibration layer 201a, the first electrode layer 201b, and the second electrode layer 201c may be buried or embedded between the first adhesive layer 202 and the second adhesive layer 204.

Each of the first adhesive layer 202 and the second adhesive layer 204 according to an embodiment of the present disclosure may include an electrical insulation material which has adhesive properties and is capable of compression and/or decompression. For example, each of the first adhesive layer 202 and the second adhesive layer 204 may include epoxy resin, acrylic resin, silicone resin, and urethane resin, but embodiments of the present disclosure are not limited thereto.

Any one of the first cover member 203 and the second cover member 205 may be attached or coupled (or connected) to the vibration member (or a vibration plate or a vibration object) via an adhesive member.

According to one embodiment of the present disclosure, any one of the first cover member 203 and the second cover member 205 may be attached to or coupled to (or connected to) the vibration member (or the vibration plate or the vibration object) via an adhesive member. For example, any one of the first cover member 203 and the second cover member 205 may be attached to or coupled to (or connected to) the vibration member 100 via an adhesive member 150 as described with reference to FIGS. 1 and 2.

The vibration device 200 according to one embodiment of the present disclosure may further include a first power supply line PL1, a second power supply line PL2, and a pad part 206.

The first power supply line PL1 may be disposed on the first cover member 203. For example, the first power supply line PL1 may be disposed between the first electrode layer 201b and the first cover member 203, and may be electrically connected to the first electrode layer 201b. The first power supply line PL1 may be elongated along the first direction X or the second direction Y, and may be electrically connected to a central portion of the first electrode layer 201b. In one embodiment, the first power supply line PL1 may be electrically connected to the first electrode layer 201b via an anisotropic conductive film. In another embodiment of the present disclosure, the first power supply line PL1 may be electrically connected to the first electrode layer 201b through a conductive material (or particles) in a first adhesive layer 202.

The second power supply line PL2 may be disposed on the second cover member 205. For example, the second power supply line PL2 may be disposed between the second electrode layer 201c and the second cover member 205, and may be electrically connected to the second electrode layer 201c. The second power supply line PL2 may be elongated along the first direction X or the second direction Y, and may be electrically connected to a central portion of the second electrode layer 201c. In one embodiment, the second power supply line PL2 may be electrically connected to the second electrode layer 201c via an anisotropic conductive film. In another embodiment, the second power supply line PL2 may be electrically connected to the second electrode layer 201c through a conductive material (or particles) in a second adhesive layer 204.

According to an embodiment of the present disclosure, a first power supply line PL1 and a second power supply line PL2 may be disposed not to overlap each other. When the first power supply line PL1 is disposed not to overlap the second power supply line PL2, a problem of a short circuit defect between the first power supply line PL1 and the second power supply line PL2 may be solved.

The pad part 206 may be electrically connected to the first power supply line PL1 and the second power supply line PL2. For example, the pad part 206 may be provided at one edge portion (or one periphery portion) of one of the first cover member 203 and the second cover member 205 so as to be electrically connected to one side (or one end or one portion) of each of the first power supply line PL1 and the second power supply line PL2.

The pad part 206 according to an embodiment of the present disclosure may include a first pad electrode which is electrically connected to one end of the first power supply line PL1 and a second pad electrode which is electrically connected to one end of the second power supply line PL2.

The first pad electrode may be disposed at one edge portion (or one periphery portion) of one of the first cover member 203 and the second cover member 205 and may be connected to one end (or one portion) of the first power supply line PL1. For example, the first pad electrode may pass through one of the first cover member 203 and the second cover member 205 and may be electrically connected to one end (or one portion) of the first power supply line PL1.

The second pad electrode may be disposed in parallel with the first pad electrode and may be connected to one end (or one portion) of the second power supply line PL2. For example, the second pad electrode may pass through one of the first cover member 203 and the second cover member 205 and may be electrically connected to one end (or one portion) of the second power supply line PL2.

According to an embodiment of the present disclosure, each of the first power supply line PL1, the second power supply line PL2, and the pad part 206 may be configured to be transparent, semitransparent, or opaque.

A pad part 206 according to an embodiment of the present disclosure may be electrically connected with a signal cable 207.

The signal cable 207 may be electrically connected with the pad part 206 disposed in the vibration device 200 and may transfer a vibration driving signal (or a sound signal or a voice signal), supplied from a sound processing circuit, to the vibration device 200. The signal cable 207 according to an embodiment of the present disclosure may include a first terminal electrically connected with a first pad electrode of the pad part 206 and a second terminal electrically connected with a second pad electrode of the pad part 206. For example, the signal cable 207 may be a flexible printed circuit board (PCB), a flexible flat cable, a single-sided flexible printed circuit, a single-sided flexible PCB, a flexible multi-layer printed circuit, or a flexible multi-layer PCB, but embodiments of the present disclosure are not limited thereto.

The sound processing circuit may generate an alternating current (AC) vibration driving signal including a first vibration driving signal and a second vibration driving signal, based on sound data provided from an external sound data generating circuit. The first vibration driving signal may be one of a positive (+) vibration driving signal and a negative (−) vibration driving signal, and the second vibration driving signal may be one of the positive (+) vibration driving signal and the negative (−) vibration driving signal. For example, the first vibration driving signal may be supplied to the first electrode layer 201b through the first terminal of the signal cable 207, the first pad electrode of the pad part 206, and a first power supply line PL1. The second vibration driving signal may be supplied to the second electrode layer 201c through the second terminal of the signal cable 207, the second pad electrode of the pad part 206, and a second power supply line PL2.

According to an embodiment of the present disclosure, the signal cable 207 may be configured to be transparent, semitransparent, or opaque.

The vibration device 200 according to an embodiment of the present disclosure may be implemented as a thin film type as a first portion having a piezoelectric characteristic and a second portion having flexibility are alternately and repeatedly connected with each other. Accordingly, the vibration device 200 may be bent in a shape corresponding to a shape of a vibration member or a vibration object. For example, when the vibration device 200 is connected with or coupled to a vibration member including various curved portions by the adhesive member 150, the vibration device 200 may be bent in a curved shape along a curved portion shape of the vibration member 100, and despite being bent in a curved shape, reliability such as damage or breakdown may not be reduced.

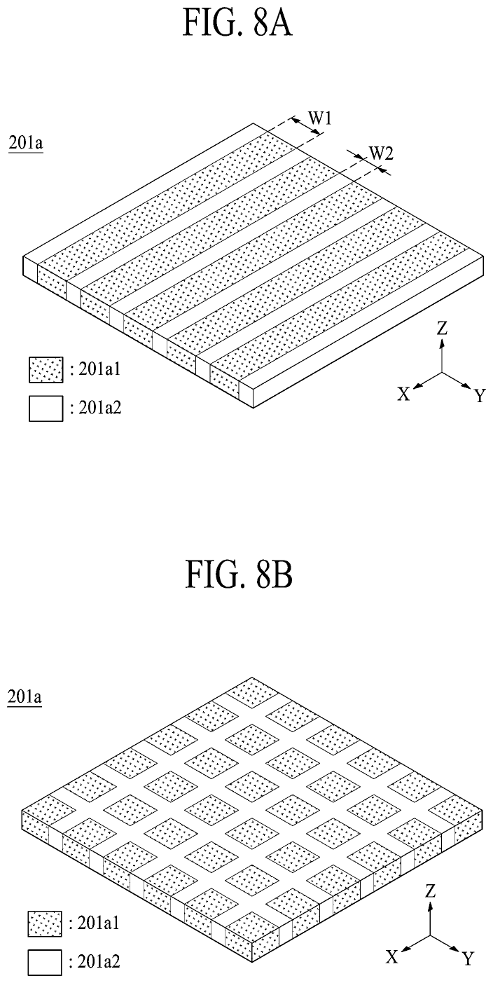

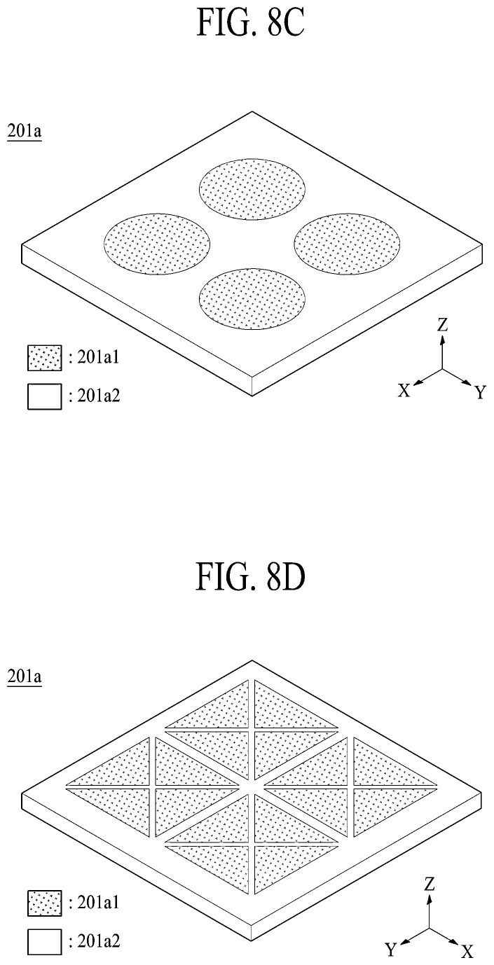

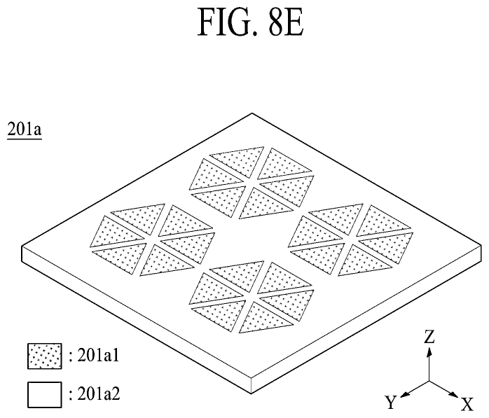

FIG. 8A illustrates a vibration layer 201a according to another embodiment of the present disclosure.

The vibration layer 201a according to another embodiment of the present disclosure may include a plurality of first portions 201a1 and a plurality of second portions 201a2. For example, the plurality of first portions 201a1 and the plurality of second portions 201a2 may be alternately and repeatedly arranged in a first direction X (or a second direction Y). For example, the first direction X may be a widthwise direction of the vibration layer 201a, and the second direction Y may be a lengthwise direction of the vibration layer 201a intersecting with the first direction X, but embodiments of the present disclosure are not limited thereto. For example, the first direction X may be the lengthwise direction of the vibration layer 201a, and the second direction Y may be the widthwise direction of the vibration layer 201a.

At least one vibration part 201 according to another embodiment of the present disclosure may be configured to have flexibility. For example, the at least one vibration part 201 may be provided to be bent in a nonplanar shape including a curved surface. Therefore, the at least one vibration part 201 according to an embodiment of the present disclosure may be a flexible vibration structure, a flexible vibrator, a flexible vibration generating device, a flexible vibration generator, a flexible sounder, a flexible sound device, a flexible sound generating device, a flexible sound generator, a flexible actuator, a flexible speaker, a flexible piezoelectric speaker, a film actuator, a film type piezoelectric composite actuator, a film speaker, a film type piezoelectric speaker, or a film type piezoelectric composite speaker, but embodiments of the present disclosure are not limited thereto.

Each of the plurality of first portions 201a1 may include an inorganic material portion. The inorganic material portion may include a piezoelectric material, a composite piezoelectric material, or an electroactive material, which has a piezoelectric effect.

Each of the plurality of first portions 201a1 may include a ceramic-based material for generating a relatively high vibration, or may include a piezoelectric ceramic having a perovskite-based crystalline structure. The perovskite crystalline structure may have a piezoelectric effect and/or an inverse piezoelectric effect, and may be a plate-shaped structure having orientation. The perovskite crystalline structure may be represented by a chemical formula “ABO₃”. In the chemical formula, “A” may include a divalent metal element, and “B” may include a tetravalent metal element. For example, in the chemical formula “ABO₃”, “A” and “B” may be cations, and “O” may be anions. For example, the first portions 201a1 may include one or more of lead(II) titanate (PbTiO₃), lead zirconate (PbZrO₃), lead zirconate titanate(PbZrTiO₃), barium titanate (BaTiO₃), and strontium titanate (SrTiO₃), but embodiments of the present disclosure are not limited thereto.

The piezoelectric ceramic may include single crystalline ceramic having a single crystalline structure, or may include polycrystalline ceramic or a ceramic material having a polycrystalline structure. A piezoelectric material of the single crystalline ceramic may include α-AlPO₄, α-SiO₂, LiNbO₃, Tb₂(MoO₄)₃, Li₂B₄O₇, or ZnO, but embodiments of the present disclosure are not limited thereto. The piezoelectric material of the single crystalline ceramic may include a lead zirconate titanate (PZT)-based material including lead (Pb), zirconium (Zr), and titanium (Ti) or may include a lead zirconate nickel niobate (PZNN)-based material including lead (Pb), zinc (Zn), nickel (Ni), and niobium (Nb), but embodiments of the present disclosure are not limited thereto.

For another example, the vibration layer 210a may include one or more of CaTiO₃, BaTiO₃, and SrTiO₃ without Pb, but embodiments of the present disclosure are not limited thereto.

Referring to FIG. 8A, each of the plurality of first portions 201a1 according to an embodiment of the present disclosure may be disposed between two adjacent second portions 201a2 of the plurality of second portions 201a2, and moreover, may have a first width W1 parallel to the first direction X (or the second direction Y) and may have a length parallel to the second direction Y (or the first direction X). Each of the plurality of second portions 201a2 may have a second width W2 parallel to the first direction X (or the second direction Y) and may have a length parallel to the second direction Y (or the first direction X). The first width W1 may be the same as or different from the second width W2. For example, the first width W1 may be greater than the second width W2. For example, the first portion 201a1 and the second portion 201a2 may include a line shape or a stripe shape having the same size or different sizes. Accordingly, the vibration layer 201a may have a 2-2 composite structure having a piezoelectric characteristic of a 2-2 vibration mode, and thus, may have a resonance frequency of 20 KHz or less, but embodiments of the present disclosure are not limited thereto. For example, the resonance frequency of the vibration layer 201a may vary based on one or more of a shape, a length, and a thickness.

In the vibration layer 201a, the plurality of first portions 201a1 and the plurality of second portions 201a2 may be disposed (or arranged) in parallel on the same plane (or the same layer). Each of the plurality of second portions 201a2 may be configured to fill a gap between two adjacent first portions 201a1, and thus, each of the plurality of second portions 201a2 may be connected to or attached on an adjacent first portion 201a1. Accordingly, the vibration layer 201a may extend by a desired size or length on the basis of lateral coupling (or connection) of the first portion 201a1 and the second portion 201a2.

In the vibration layer 201a, the width W2 of each of the plurality of second portions 201a2 may decrease progressively in a direction from a center portion of the vibration layer 201a to both edge portions (or both ends or both periphery portions) thereof.

According to an embodiment of the present disclosure, when the vibration layer 201a vibrates in a vertical direction Z (or a thickness direction), a second portion 201a2 having a largest width W2 among a plurality of second portions 201a2 may be disposed at a portion on which a largest stress concentrates. When the vibration layer 201 a vibrates in the vertical direction Z, a second portion 201a2 having a smallest width W2 among the plurality of second portions 201a2 may be disposed at a portion on which a smallest stress concentrates. For example, the second portion 201a2 having the largest width W2 among the plurality of second portions 201a2 may be disposed at a center portion of the vibration layer 201a, and the second portion 201a2 having the smallest width W2 among the plurality of second portions 201a2 may be disposed at both edge portions (or both periphery portions) of the vibration layer 201a. Accordingly, when the vibration layer 201a vibrates in the vertical direction Z, an overlap of a resonance frequency or interference of a sound wave generated at a portion on which the largest stress concentrates may be minimized, and thus, the dip of a sound pressure level occurring in a low-pitched sound band may be improved and the flatness of a sound characteristic in the low-pitched sound band may be improved.

In the vibration layer 201a, the plurality of first portions 201a1 may have different sizes (or widths). For example, a size (or a width) of each of the plurality of first portions 201a1 may decrease or increase progressively in a direction from the center portion of the vibration layer 201a to both edge portions (or both ends or both periphery portions) thereof. Therefore, a sound pressure level characteristic of a sound of the vibration layer 201a may be enhanced by various unique vibration frequencies based on vibrations of the plurality of first portions 201a1 having different sizes, and a reproduction band of a sound may extend.

Each of the plurality of second portions 201a2 may be disposed between the plurality of first portions 201a1. Therefore, in the vibration layer 201a, vibration energy based on a link in a unit lattice of the first portion 201a1 may be increased by the second portion 201a2, and thus, a vibration characteristic may increase and a piezoelectric characteristic and flexibility may be secured. For example, the second portion 201a2 may include one of an epoxy-based polymer, an acrylic-based polymer, and a silicone-based polymer, but embodiments of the present disclosure are not limited thereto.

Each of the plurality of second portions 201a2 according to an embodiment of the present disclosure may include an organic material portion. For example, each of the organic material portions may be disposed between two adjacent inorganic material portions of the plurality of inorganic material portions, and thus, may absorb an impact applied to a corresponding inorganic material portion (or a first portion), a stress concentrating on the inorganic material portion may be released to enhance the durability of the vibration layer 201a, and flexibility may be provided to the vibration layer 201a. Accordingly, the vibration device 200 may be configured to have flexibility.

The second portion 201a2 according to an embodiment may have modulus (or Young's modulus) and viscoelasticity which are lower than those of the first portion 201a1, and thus, may enhance the reliability of the first portion 201a1 which is vulnerable to an impact due to a fragile characteristic thereof. For example, the second portion 201a2 may include a material which has a loss coefficient of 0.01 to 1 and a modulus of 0.1 Gpa to 10 Gpa (Gigapascal).

The organic material portion included in the second portion 201a2 may include an organic material, an organic polymer, an organic piezoelectric material, or an organic non-piezoelectric material having a flexible characteristic compared to the inorganic material portion which is the first portion 201a1. For example, the second portion 201a2 may be referred to as an adhesive portion, a flexible portion, a bending portion, a damping portion, or a ductile portion, or the like, but embodiments of the present disclosure are not limited thereto.

The plurality of first portions 201a1 and the plurality of second portions 201a2 may be disposed on (or connected to) the same plane, and thus, the vibration layer 201a according to an embodiment of the present disclosure may have a single thin film form. For example, the vibration layer 201a may have a structure where the plurality of first portions 201a1 are connected to one side thereof. For example, the vibration layer 201a may have a structure where the plurality of first portions 201a1 are connected in all of the vibration layer 201a. For example, the vibration layer 201a may be vibrated in a vertical direction by the first portion 201a1 having a vibration characteristic and may be bent in a curved shape by the second portion 201a2 having flexibility. Also, in the vibration layer 201 a according to an embodiment of the present disclosure, a size of the first portion 201a1 and a size of the second portion 201a2 may be adjusted based on a piezoelectric characteristic and flexibility needed for the vibration layer 201a. For example, in the vibration layer 201a requiring a piezoelectric characteristic rather than flexibility, a size of the first portion 201a1 may be adjusted to be greater than that of the second portion 201a2. In another embodiment of the present disclosure, in the vibration layer 201a requiring flexibility rather than a piezoelectric characteristic, a size of the second portion 201a2 may be adjusted to be greater than that of the first portion 201a1. Accordingly, a size of the vibration layer 201a may be adjusted based on a desired characteristic, and thus, the vibration layer 201a may be easily designed.

Referring to FIG. 8B, the vibration layer 201a according to another embodiment of the present disclosure may include a plurality of first portions 201a1, which are spaced apart from one another in a first direction X and a second direction Y, and a second portion 201a2 disposed between the plurality of first portions 201al.

The plurality of first portions 201a1 may be arranged apart from one another in each of the first direction X and the second direction Y. For example, the plurality of first portions 201a1 may be arranged in a lattice form to have a hexahedral shape having the same size. Each of the plurality of first portions 201a1 may include substantially the same piezoelectric material as that of the first portion 201a1 described above with reference to FIG. 8A, and thus, like reference numerals refer to like elements and repeated descriptions thereof may be omitted.

The second portion 201a2 may be arranged between the plurality of first portions 201a1 in each of the first direction X and the second direction Y. The second portion 201a2 may be configured to fill a gap between two adjacent first portions 201a1 or surround each of the plurality of first portions 201a1, and thus, may be connected or adhered to an adjacent first portion 201a1. According to an embodiment of the present disclosure, a width of the second portion 201a2 disposed between two first portions 201a1 adjacent to each other in the first direction X may be the same as or different from that of the first portion 201a1, and a width of the second portion 201a2 disposed between two first portions 201a1 adjacent to each other in the second direction Y may be the same as or different from that of the first portion 201a1. The second portion 201a2 may include substantially the same piezoelectric material as that of the second portion 201a2 described above with reference to FIG. 8A, and thus, like reference numerals refer to like elements and repeated descriptions thereof may be omitted.

The vibration layer 201a according to another embodiment of the present disclosure may have a 1-3 composite structure having a piezoelectric characteristic of a 1-3 vibration mode, and thus, may have a resonance frequency of 30 MHz or less, but embodiments of the present disclosure are not limited thereto. For example, the resonance frequency of the vibration layer 201a may vary based on one or more of a shape, a length, and a thickness.

Referring to FIG. 8C, in the vibration layer 201a according to another embodiment of the present disclosure, each of the plurality of first portions 201a1 may have a circular flat structure. For example, each of the plurality of first portions 201a1 may have a circular plate shape, but embodiments of the present disclosure are not limited thereto. For example, each of the plurality of first portions 201a1 may have a dot shape including an oval shape, a polygonal shape, or a donut shape. The vibration layer 201a may include a plurality of first portions 201a1, which are spaced apart from one another in the first direction X and the second direction Y, and a second portion 201a2 between the plurality of first portions 201a1.

In the vibration layer 201a according to another embodiment of the present disclosure, each of the plurality of first portions 201a1 may have a triangular flat structure. For example, each of the plurality of first portions 201a1 may have a triangular plate shape.

Referring to FIG. 8D, four adjacent first portions 201a1 of the plurality of first portions 201a1 may be arranged adjacent to one another to form a tetragonal shape (or a square shape). A vertex of each of four adjacent first portions 201a1 forming a tetragonal shape may be disposed adjacent to a center portion (or a middle portion) of a tetragonal shape.

Referring to FIG. 8E, six adjacent first portions 201a1 of the plurality of first portions 201a1 may be arranged adjacent to one another to form a hexagonal (or a regular hexagonal shape). A vertex of each of six adjacent first portions 201a1 forming a hexagonal shape may be disposed adjacent to a center portion (or a middle portion) of a hexagonal shape.

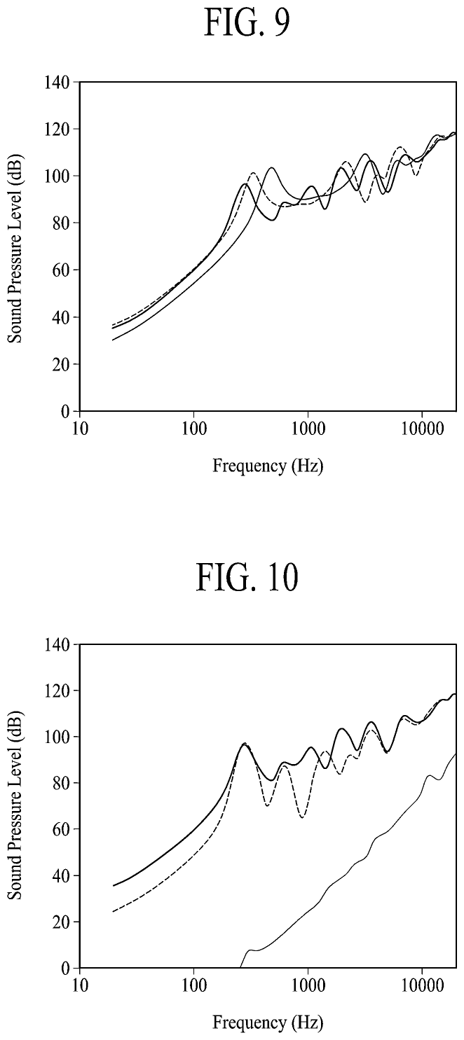

FIG. 9 illustrates a sound output characteristic of an apparatus according to an experimental example and an embodiment of the present disclosure. In FIG. 9, the abscissa axis represents a frequency (hertz, Hz), and the ordinate axis represents a sound pressure level (SPL) (decibel, dB).

In FIG. 9, a thick solid line represents a sound output characteristic of the apparatus 1 according to an embodiment of the present disclosure illustrated in FIG. 2. A dotted line represents a sound output characteristic of an apparatus according to an experimental example where an internal space is not provided in a vibration member and a thickness of the vibration member is set to 2 mm. A thin solid line represents a sound output characteristic of an apparatus according to an experimental example where an internal space is not provided in a vibration member and a thickness of the vibration member is set to 3 mm. A thickness of a vibration member does not limit the details of the present disclosure.

A sound output characteristic of an apparatus may be measured by a sound analysis apparatus. The sound analysis apparatus may include a sound card which transmits or receives a sound to or from a control personal computer (PC), an amplifier which amplifies a signal generated from the sound card and transfers the amplified signal to a vibration apparatus, and a microphone which collects a sound generated in a rear region of the apparatus on the basis of driving of the vibration apparatus. The sound collected through the microphone may be input to the control PC through the sound card, and a control program may check the input sound to analyze a peak response time of the apparatus.

A sound output characteristic has been measured in a half anechoic room. In measuring, a driving voltage is 5 Vrms, an applied frequency signal has been applied as a sine sweep within a range of 20 Hz to 2 kHz, and ⅓ octave smoothing has been performed on a measurement result. A separation distance between a rearmost surface of an apparatus and a microphone is 50 cm. A measurement method is not limited thereto.

As seen in FIG. 9, comparing with the dotted line and the thin solid line, in the thick solid line, it may be seen that the peak of a sound moves to a low-pitched sound band. For example, in the thick solid line, it may be seen that a resonance point of primary peak moves to 270 Hz and moves to the low-pitched sound band instead of 350 Hz of the dotted line and 504 Hz of the thin solid line. In the vibration member including the internal space, a frequency of a primary peak or a primary resonance point may be 270 Hz and the stiffness of the vibration member may be less than that of a vibration member without internal space, and thus, a resonance point may move to the low-pitched sound band. Therefore, when a vibration member including an internal space is applied to an apparatus, it may be seen that a sound characteristic and/or a sound pressure level characteristic of a low-pitched sound band of a sound increase or are/is improved. According to an embodiment of the present disclosure, when a vibration member including an internal space is applied to an apparatus, a frequency of a primary peak or a primary resonance point may be changed, and thus, it may be seen that a sound characteristic and/or a sound pressure level characteristic of a low-pitched sound band of a sound increase or are/is improved.

FIG. 10 illustrates a sound output characteristic of an apparatus according to an experimental example and an embodiment of the present disclosure. In FIG. 10, the abscissa axis represents a frequency (hertz, Hz), and the ordinate axis represents a sound pressure level (SPL) (decibel, dB).

In FIG. 10, a thick solid line represents a sound output characteristic of the apparatus 1 according to an embodiment of the present disclosure illustrated in FIG. 2. A dotted line represents a sound output characteristic of an apparatus according to an experimental example where an internal space of a vibration member is configured to be vacuum. A thin solid line represents a sound output characteristic of an apparatus according to an experimental example where an internal space of a vibration member is provided not to be closed. A measurement method of a sound output characteristic may be the same as the descriptions of FIG. 9, and thus, descriptions thereof may be omitted.

As seen in FIG. 10, comparing with each of a dotted line and a thin solid line, in a thick solid line, it may be seen that a sound pressure level of a low-pitched sound band of 300 Hz or less is improved and dip of a sound pressure level in a full frequency domain are improved, and thus, the flatness of a sound pressure level is improved. Therefore, when an internal space of a vibration member has a closed structure where air is filled, it may be seen that the peak and dip of a sound pressure level in each of a low-pitched sound band and a high-pitched sound band are improved, and the flatness of a sound pressure level in a full frequency domain is improved. For example, because an air spring effect is reduced when an internal space of a vibration member is vacuum, it may be difficult to vibrate the second vibration member 102, and thus, it may be seen that the peak and dip of a sound pressure level increase after a primary resonance point. For example, in the air spring effect, an air layer in the internal space of the vibration member may function as a spring and may transfer a vibration of the first vibration member 101 to the second vibration member 102. For example, because the air spring effect is reduced when the internal space of the vibration member is in a vacuum state, a vibration of the first vibration member 101 may not be transferred to the internal space and may be transferred by only the third vibration member 103, and thus, it may be seen that the peak and dip of a sound pressure level increase. According to an embodiment of the present disclosure, when the internal space of the vibration member has a closed structure where air is filled, a vibration of the first vibration member 101 may be transferred to the second vibration member 102, and a sound pressure level characteristic of the low-pitched sound band may be enhanced. For example, when the internal space of the vibration member is filled with air or a gas, a vibration of the first vibration member 101 may be transferred to the second vibration member 102 through the air or gas of the internal space and the first vibration member 101 and the second vibration member 102 may vibrate at the same frequencies or similar frequencies, and thus, it may be seen that a sound pressure level characteristic of the low-pitched sound band is enhanced and the peak and dip of a sound pressure level are reduced. For example, when the internal space of the vibration member is filled with air or a gas, the first vibration member 101 may push the air or gas of the internal space and thus a vibration of the first vibration member 101 may be transferred to the second vibration member 102, and the first vibration member 101 and the second vibration member 102 may vibrate at the same frequencies or similar frequencies, whereby it may be seen that a sound pressure level characteristic of the low-pitched sound band is enhanced and the peak and dip of a sound pressure level are reduced. For example, when the internal space of the vibration member is filled with air or a gas, the first vibration member 101 may push the air or gas of the internal space and thus a vibration of the first vibration member 101 may be transferred to the second vibration member 102, and the first vibration member 101 and the second vibration member 102 may vibrate together, whereby a sound pressure level characteristic may be enhanced.

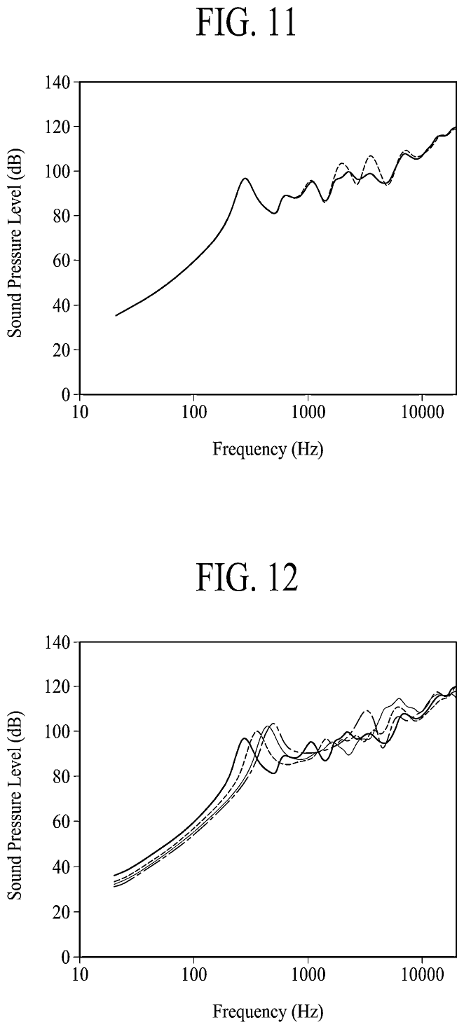

FIG. 11 illustrates a sound characteristic of an apparatus according to an embodiment of the present disclosure. In FIG. 11, the abscissa axis represents a frequency (Hz), and the ordinate axis represents a sound pressure level (SPL) (dB).

In FIG. 11, a thick solid line represents a sound output characteristic of the apparatus 2 according to an embodiment of the present disclosure illustrated in FIGS. 3 and 4. A dotted line represents a sound output characteristic of the apparatus 1 according to an embodiment of the present disclosure illustrated in FIG. 2. A measurement method of a sound output characteristic may be the same as the descriptions of FIG. 9, and thus, descriptions thereof may be omitted.

As seen in FIG. 11, a thick solid line and a dotted line represent that a sound pressure level is improved in a low-pitched sound band of 300 Hz, and comparing with the dotted line, in the thick solid line, it may be seen that the peak and dip of a sound pressure level are improved in a high-pitched sound band of 1 kHz, and thus, the flatness of a sound pressure level is improved. Therefore, when a vibration member including an internal space is applied to an apparatus, it may be seen that a sound characteristic and/or a sound pressure level characteristic of the low-pitched sound band of a sound increase or are/is improved, and when a middle member is further applied to the internal space of the vibration member, it may be seen that the peak and dip of a sound pressure level in the high-pitched sound band is reduced, and thus, the flatness of a sound pressure level is improved. According to an embodiment of the present disclosure, when the middle member is provided, peak and/dip may be improved in a frequency of 1 kHz or more, and thus, it may be seen that the flatness of a sound pressure level is improved.

FIG. 12 illustrates a sound characteristic of an apparatus according to an experimental example and an embodiment of the present disclosure. In FIG. 12, the abscissa axis represents a frequency (Hz), and the ordinate axis represents a sound pressure level (SPL) (dB).

In FIG. 12, a thick solid line represents a sound output characteristic of the apparatus 2 according to another embodiment of the present disclosure illustrated in FIGS. 3 and 4. A dotted line represents a sound output characteristic of the apparatus 2 according to another embodiment of the present disclosure illustrated in FIG. 5. A thin solid line represents a sound output characteristic of an apparatus where the number of middle members applied to an internal space of a vibration member is 27. A dash-single dotted line represents a sound output characteristic of an apparatus according to an experimental example where an internal space is not provided in a vibration member and a thickness of the vibration member is set to 3 mm. A measurement method of a sound output characteristic may be the same as the descriptions of FIG. 9, and thus, descriptions thereof may be omitted. A thickness of the vibration member 101 and the number of middle members do not limit the details of the present disclosure.

As seen in FIG. 12, comparing with a dash-single dotted line, in each of a thick solid line, a dotted line, and a thin solid line, it may be seen that the peak of a sound moves to a low-pitched sound band, and the peak and dip of a sound pressure level is improved in a high-pitched sound band of 1 kHz. For example, it may be seen that the thin solid line represents that the peak of a sound moves to a sound band which is lower than the dash-single dotted line, the dotted line represents that the peak of a sound moves to a sound band which is lower than the thin solid line, and the thick solid line represents that the peak of a sound moves to a sound band which is lower than the dotted line. Also, comparing with the thick solid line, in each of the thin solid line and the dotted line, it may be seen that the peak and dip of a sound pressure level are more improved in the high-pitched sound band of 1 KHz. Therefore, when the number of middle members in an internal space of a vibration member is relatively small, it may be seen that a sound characteristic and/or a sound pressure level characteristic of the low-pitched sound band of a sound increase or are/is improved, and when the number of middle members in the internal space of the vibration member is relatively large, it may be seen that the peak and dip of the high-pitched sound band of a sound are improved, and thus, the flatness of a sound pressure level is improved. According to an embodiment of the present disclosure, as the number of middle member increases, a resonance frequency may increase to 261 Hz, 277 Hz, 334 Hz, and 437 Hz, and thus, it may be seen that peak and dip are improved in a frequency of the high-pitched sound band. According to an embodiment of the present disclosure, as the number of middle member increases, a mechanical coupling effect may increase, and thus, it may be seen that peak and dip are improved in a frequency of the high-pitched sound band, and thus, the flatness of a sound pressure level is improved. For example, in a case where the internal space of the vibration member is filled with only air or a gas, delay may occur in the vibration transfer of a high frequency due to a low sound wave transfer speed of air or a gas, and due to this, destructive interference between a vibration of the first vibration member 101 and a vibration of the second vibration member 102 may occur, causing a reduction in sound pressure level in the high-pitched sound band and an increase in peak and dip. Therefore, according to an embodiment of the present disclosure, as the middle member is provided in the internal space of the vibration member, mechanical coupling between the first vibration member 101 and the second vibration member 102 may be formed, and thus, the delay of the vibration transfer of a high frequency is prevented or reduced, whereby it may be seen that a sound pressure level characteristic of the high-pitched sound band is enhanced and the peak and dip of a sound pressure level are reduced. According to an embodiment of the present disclosure, because the middle member for physically binding the first vibration member 101 and the second vibration member 102 is provided in the internal space of the vibration member, the delay of the vibration transfer of a high frequency may be prevented, and peak and dip may be reduced. For example, the second vibration member 102 may vibrate based on air particles, and the first vibration member 101 and the second vibration member 102 may vibrate in the high-pitched sound band at the same speed and the same time by the middle member. Therefore, a sound pressure level characteristic may be enhanced in the high-pitched sound band, and the peak and dip of a sound pressure level may decrease. According to an embodiment of the present disclosure, the strength of mechanical coupling between the first vibration member 101 and the second vibration member 102 in the high-pitched sound band may increase based on the number of middle members, and thus, a vibration mode of the first vibration member 101 and a vibration mode of the second vibration member 102 may be similar to each other in the high-pitched sound band, whereby the peak and dip of a sound pressure level may be reduced.

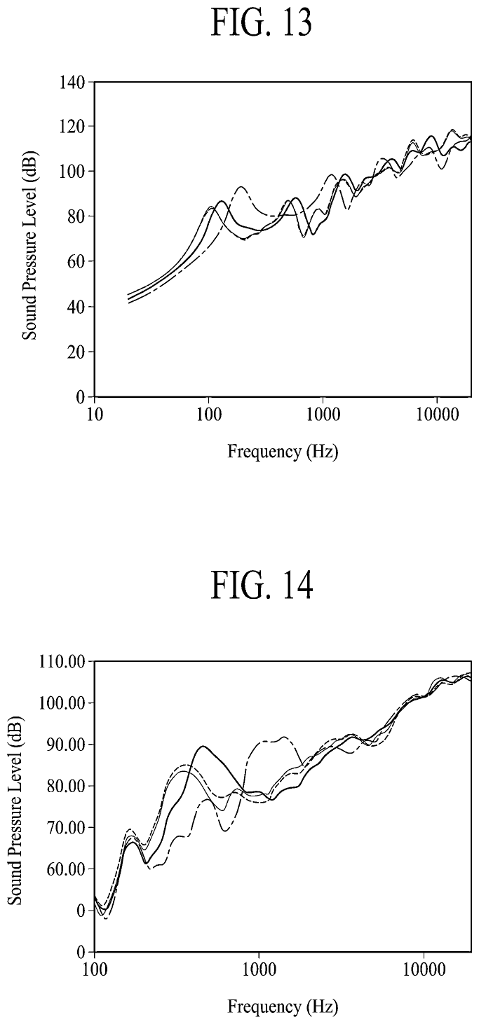

FIG. 13 illustrates a sound characteristic of an apparatus according to an experimental example and an embodiment of the present disclosure. In FIG. 13, the abscissa axis represents a frequency (Hz), and the ordinate axis represents a sound pressure level (SPL) (dB).

In FIG. 13, a thick solid line represents a sound output characteristic of an apparatus where each of a thickness of the first vibration member 101, a thickness of the second vibration member 102, and an interval (distance) between the first vibration member 101 and the second vibration member 102 is set to 0.34 mm in the apparatus 2 according to another embodiment of the present disclosure illustrated in FIG. 5. A thin solid line represents a sound output characteristic of an apparatus where each of a thickness of the first vibration member 101, a thickness of the second vibration member 102, and an interval between the first vibration member 101 and the second vibration member 102 is set to 0.34 mm in the apparatus 2 according to another embodiment of the present disclosure illustrated in FIG. 4. A dotted line represents a sound output characteristic of an apparatus where each of a thickness of the first vibration member 101, a thickness of the second vibration member 102, and an interval between the first vibration member 101 and the second vibration member 102 is set to 0.34 mm in the apparatus 1 according to another embodiment of the present disclosure illustrated in FIG. 2. A dash-single dotted line represents a sound output characteristic of an apparatus according to an experimental example where an internal space is not provided in a vibration member and a thickness of the vibration member is set to 1.02 mm. A measurement method of a sound output characteristic may be the same as the descriptions of FIG. 9, and thus, descriptions thereof may be omitted. Each of a thickness of the first vibration member 101, a thickness of the second vibration member 102, and an interval between the first vibration member 101 and the second vibration member 102 does not limit the details of the present disclosure.

Comparing with FIG. 12, in FIG. 13, it may be seen that the peak of a sound moves to a low-pitched sound band as a thickness of the first vibration member 101, the second vibration member 102, and the internal space AG configuring the vibration member 100 is progressively thinned. For example, in a frequency range of 100 Hz to 400 Hz, it may be seen that the peak of a sound is adjusted based on a thickness of the vibration member 100 and the number of middle members 105 included in the vibration member 100. Therefore, it may be seen that flatness and a sound pressure level characteristic needed for an apparatus may be adjusted based on the number of middle members and a thickness of a vibration member including an internal space. According to an embodiment of the present disclosure, it may be seen that a primary resonance frequency is lowered as a thickness of the vibration member 100 is progressively thinned. According to an embodiment of the present disclosure, when an internal space and a middle member are applied, it may be seen that the primary resonance frequency is lowered up to a frequency of a low-pitched sound band which is relatively low, and thus, a sound pressure level of the low-pitched sound band is improved. For example, as a thickness of a vibration member is progressively thinned, the primary resonance frequency may be lowered and a sound pressure level may be reduced together, but because the vibration member 100 according to an embodiment of the present disclosure may include the first vibration member 101, the second vibration member 102, and the internal space AG, a thickness may be partially reduced while maintaining a total thickness of a vibration member, whereby it may be seen that a sound characteristic and/or a sound pressure level characteristic of the low-pitched sound band may be increased or improved because the primary resonance frequency is lowered without a reduction in sound pressure level. Accordingly, it may be seen that a sound characteristic and/or a sound pressure level characteristic are/is increased or improved in a full-pitched sound band including a low-pitched sound band.

FIG. 14 illustrates a sound characteristic of an apparatus according to an experimental example and an embodiment of the present disclosure. In FIG. 14, the abscissa axis represents a frequency (Hz), and the ordinate axis represents a sound pressure level (SPL) (dB).

In FIG. 14, a thick solid line represents a sound output characteristic of the apparatus 2 according to another embodiment of the present disclosure illustrated in FIG. 5. A dotted line represents a sound output characteristic of the apparatus 2 according to another embodiment of the present disclosure illustrated in FIG. 4. A thin solid line represents a sound output characteristic of the apparatus 1 according to an embodiment of the present disclosure illustrated in FIG. 2. A dash-single dotted line represents a sound output characteristic of an apparatus according to an experimental example where an internal space is not provided in a vibration member and a thickness of the vibration member is set to 3 mm. A measurement method of a sound output characteristic may be the same as the descriptions of FIG. 9, and thus, descriptions thereof may be omitted. A sound output characteristic has been measured in a half anechoic room. In measuring, a driving voltage is 5 Vrms, an applied frequency signal has been applied as a sine sweep within a range of 100 Hz to 2 kHz, and ⅓ octave smoothing has been performed on a measurement result. A separation distance between a rearmost surface of an apparatus and a microphone is 50 cm. A measurement method is not limited thereto. A sound output characteristic has been measured in a half anechoic room. In measuring, a driving voltage is 5 Vrms, an applied frequency signal has been applied as a sine sweep within a range of 20 Hz to 2 KHz, and ⅓ octave smoothing has been performed on a measurement result. A separation distance between a rearmost surface of an apparatus and a microphone is 50 cm. A measurement method is not limited thereto.

As seen in FIG. 14, comparing with a dash-single dotted line, in each of a thick solid line, a dotted line, and a thin solid line, it may be seen that a sound pressure level increases in a sound band of 100 Hz to 1 kHz (for example, a sound band of 100 Hz to 800 Hz). Also, comparing with a dash-single dotted line, in each of the thick solid line, the dotted line, and the thin solid line, it may be seen that the peak and dip of a sound band of 1 kHz or more are reduced, and the flatness of a sound pressure level is improved in a full frequency domain. Accordingly, in the apparatus according to an embodiment of the present disclosure, a sound characteristic and/or a sound pressure level characteristic of a low-pitched sound band of a sound increase or are/is improved, and the flatness of a sound pressure level in a full frequency domain is improved or enhanced. According to an embodiment of the present disclosure, in each of the thick solid line, the dotted line, and the thin solid line, it may be seen that a resonance frequency is moved to a frequency of the low-pitched sound band by an internal space, and thus, a sound pressure level is enhanced in a sound band of 1 kHz or less. According to an embodiment of the present disclosure, in each of the thick solid line, the dotted line, and the thin solid line, because an internal space and a middle member are provided, it may be seen that out-coupling is prevented in a frequency of a high-pitched sound band after a resonance point through diagram coupling, and thus, the peak and dip of a sound pressure level are improved. For example, the diagram coupling may prevent the distortion of a vibration mode between the first vibration member 101 and the second vibration member 102 in the high-pitched sound band by the middle member. For example, in the out-coupling, mechanical coupling between the first vibration member 101 and the second vibration member 102 may not be formed (for example, the first vibration member 101 and the second vibration member 102 may not vibrate in the same vibration mode) when a middle member is not provided, and the first vibration member 101 and the second vibration member 102 may vibrate in different vibration modes, whereby the peak and dip of a sound pressure level may increase. For example, when all of an internal space and a middle member are provided in a vibration member, the mechanical coupling between the first vibration member 101 and the second vibration member 102 may be formed, and thus, the delay of the vibration transfer of a high frequency may be prevented or reduced. Accordingly, a vibration mode of the first vibration member 101 may match a vibration mode of the second vibration member 102, and thus, it may be seen that a sound pressure level of the high-pitched sound band is enhanced and the peak and dip of a sound pressure level are reduced.

An apparatus according to various embodiments of the present disclosure will be described below.

An apparatus according to various embodiments of the present disclosure may include a vibration member including an internal space, and a vibration device configured to vibrate the vibration member.

According to various embodiments of the present disclosure, the vibration device may overlap the internal space.

According to various embodiments of the present disclosure, at least a portion of the internal space may overlap the vibration device.

According to various embodiments of the present disclosure, a size of the internal space may be different from a size of the vibration device in a horizontal direction of the vibration member, or may be greater than or equal to the size of the vibration device.

According to various embodiments of the present disclosure, a center portion of the vibration device may overlap a center portion of the internal space.

According to various embodiments of the present disclosure, the internal space may be isolated from the outside.

According to various embodiments of the present disclosure, the internal space may be configured with (filled with) a gas, optionally with air.

According to various embodiments of the present disclosure, the vibration member may include a first vibration member, and a second vibration member arranged in parallel with the first vibration member with the internal space therebetween.

According to various embodiments of the present disclosure, the internal space may be surrounded by the first vibration member and the second vibration member.

According to various embodiments of the present disclosure, the first vibration member and the second vibration member may include a same material or a single material.

According to various embodiments of the present disclosure, the first vibration member may have the same thickness as a thickness of the second vibration member.

According to various embodiments of the present disclosure, a distance between the first vibration member and the second vibration member may be equal to a thickness of the first vibration member.

According to various embodiments of the present disclosure, the apparatus may further include one or more middle members provided in the internal space.

According to various embodiments of the present disclosure, the one or more middle members may be connected with the first vibration member and the second vibration member.

According to various embodiments of the present disclosure, the one or more middle members may include the same material as a material of the vibration member.

According to various embodiments of the present disclosure, the one or more middle members may overlap the vibration device.

According to various embodiments of the present disclosure, the one or more middle members may overlap one or more of a center portion of the vibration device and a periphery portion of the vibration device.

According to various embodiments of the present disclosure, the one or more middle members may include a plurality of middle members. The plurality of middle members may be arranged to have a same interval (distance) in a first direction and/or a same interval (distance) in a second direction intersecting with the first direction.

According to various embodiments of the present disclosure, the apparatus may further include a third vibration member connecting the first vibration member with the second vibration member.

According to various embodiments of the present disclosure, the internal space may be surrounded by the first vibration member, the second vibration member, and the third vibration member.

According to various embodiments of the present disclosure, the first vibration member, the second vibration member, and the third vibration member may include a same material or a single material.

According to various embodiments of the present disclosure, the vibration device may include a vibration layer, a first electrode layer at a first surface of the vibration layer, and a second electrode layer at a second surface different from the first surface of the vibration layer.

According to various embodiments of the present disclosure, the vibration layer may include a piezoelectric layer.

According to various embodiments of the present disclosure, the vibration layer may include a plurality of inorganic material portions having a piezoelectric characteristic, and an organic material portion between the plurality of inorganic material portions.

According to various embodiments of the present disclosure, the vibration device may be arranged in a bent shape. And optionally the vibration device may be bent in a shape corresponding to the vibration member and/or the vibration device may comprises a flexible structure.

An apparatus according to an embodiment of the present disclosure may be applied to or included in a sound apparatus provided in the apparatus. The apparatus according to an embodiment of the present disclosure may be applied to or included in mobile apparatuses, video phones, smart watches, watch phones, wearable apparatuses, foldable apparatuses, rollable apparatuses, bendable apparatuses, flexible apparatuses, curved apparatuses, sliding apparatus, variable apparatus, electronic organizers, electronic book, portable multimedia players (PMPs), personal digital assistants (PDAs), MP3 players, mobile medical apparatuses, desktop personal computers (PCs), laptop PCs, netbook computers, workstations, navigation apparatuses, automotive navigation apparatuses, automotive display apparatuses, automotive apparatuses, theatre apparatuses, theatre display apparatuses, televisions (TVs), wall paper display apparatuses, signage apparatuses, game machines, notebook computers, monitors, cameras, camcorders, home appliances, etc. Also, the sound apparatus according to embodiments of the present disclosure may be applied to or included in organic light emitting lighting apparatuses or inorganic light emitting lighting apparatuses. In a case where the sound apparatus is applied to or included in a lighting apparatus, the sound apparatus may act as lighting and a speaker. Also, in a case where the sound apparatus according to embodiment of the present disclosure is applied to or included in a mobile apparatus, the sound apparatus may be one or more of a speaker, a receiver, or a haptic, but embodiments of the present disclosure are not limited thereto.

It will be apparent to those skilled in the art that various modifications and variations can be made in the apparatus of the present disclosure without departing from the technical idea or scope of the disclosure. Thus, it is intended that the present disclosure cover the modifications and variations of this disclosure provided that within the scope of the claims and their equivalents.

What is claimed is:

1. An apparatus, comprising:
a vibration member including an internal space; and
a vibration device configured to vibrate the vibration member.

2. The apparatus of claim 1, wherein the vibration device overlaps the internal space.

3. The apparatus of claim 1, wherein at least a portion of the internal space overlaps the vibration device.

4. The apparatus of claim 3, wherein a size of the internal space is different from a size of the vibration device in a horizontal direction of the vibration member, or is greater than or equal to the size of the vibration device.

5. The apparatus of claim 3, wherein a center portion of the vibration device overlaps a center portion of the internal space.

6. The apparatus of claim 1, wherein the internal space is isolated from the outside.

7. The apparatus of claim 6, wherein the internal space is filled with a gas, optionally with air.

8. The apparatus of claim 1, wherein the vibration member comprises:
a first vibration member; and
a second vibration member arranged in parallel with the first vibration member with the internal space therebetween.

9. The apparatus of claim 8, wherein the internal space is surrounded by the first vibration member and the second vibration member.

10. The apparatus of claim 8, wherein the first vibration member and the second vibration member comprise a same material or a single material.

11. The apparatus of claim 8, wherein the first vibration member has the same thickness as a thickness of the second vibration member.

12. The apparatus of claim 11, wherein a distance between the first vibration member and the second vibration member is equal to a thickness of the first vibration member.

13. The apparatus of claim 8, further comprising one or more middle members provided in the internal space.

14. The apparatus of claim 13, wherein the one or more middle members are connected with the first vibration member and the second vibration member.

15. The apparatus of claim 13, wherein the one or more middle members comprise the same material as a material of the vibration member.

16. The apparatus of claim 13, wherein the one or more middle members overlap the vibration device.

17. The apparatus of claim 16, wherein the one or more middle members overlap one or more of a center portion of the vibration device and a periphery portion of the vibration device.

18. The apparatus of claim 13, wherein the one or more middle members comprise a plurality of middle members, and
wherein the plurality of middle members are arranged to have a same distance in a first direction and/or a same distance in a second direction intersecting with the first direction.

19. The apparatus of claim 8, further comprising a third vibration member connecting the first vibration member with the second vibration member.

20. The apparatus of claim 19, wherein the internal space is surrounded by the first vibration member, the second vibration member, and the third vibration member.

21. The apparatus of claim 19, wherein the first vibration member, the second vibration member, and the third vibration member comprise a same material or a single material.

22. The apparatus of claim 1, wherein the vibration device comprises:
a vibration layer;
a first electrode layer at a first surface of the vibration layer; and
a second electrode layer at a second surface different from the first surface of the vibration layer.

23. The apparatus of claim 22, wherein the vibration layer comprises a piezoelectric layer.

24. The apparatus of claim 22, wherein the vibration layer comprises:
a plurality of inorganic material portions having a piezoelectric characteristic; and
an organic material portion between the plurality of inorganic material portions.

25. The apparatus of claim 1, wherein the vibration device is arranged in a bent shape; and
optionally wherein the vibration device is bent in a shape corresponding to the vibration member and/or wherein the vibration device comprises a flexible structure.
